(19) United States
(12) Patent Application Publication
(10) Pub. No.: US 2026/0138428 A1
(43) Pub. Date: May 21, 2026

(54) VEHICLE TAILGATE AIR CURTAIN AND OPERATION METHOD THEREOF

(71) Applicants: HYUNDAI MOTOR COMPANY, SEOUL (KR); KIA CORPORATION, SEOUL (KR)

(72) Inventor: Hyunsu Kim, Hwaseong-si (KR)

(73) Assignees: HYUNDAI MOTOR COMPANY, SEOUL (KR); KIA CORPORATION, SEOUL (KR)

(21) Appl. No.: 19/215,950

(22) Filed: May 22, 2025

(30) Foreign Application Priority Data
Nov. 15, 2024 (KR) 10-2024-0162652

(51) Int. Cl. B60J 9/04; B60H 1/24

(52) U.S. Cl. CPC B60J 9/04; B60H 1/244

(57) ABSTRACT

A vehicle tailgate air curtain may include a tailgate attached to a first portion of a cargo compartment frame of a vehicle, an air curtain attached to a second portion of the cargo compartment frame, and an air guide attached adjacent to the first portion of the cargo compartment frame. When the tailgate is open, an inner side surface of the tailgate has a round shape in a direction away from the air curtain, the air guide is disposed between the tailgate and the first portion, and the air curtain is disposed opposite to the air guide.

### CROSS REFERENCE TO RELATED APPLICATIONS

This application claims priority to and the benefit of Korean Patent Application No. 10-2024-0162652 filed in the Korean Intellectual Property Office on November 15, 2024, the entire contents of which is incorporated herein by reference.

### BACKGROUND

### (a) Field

The present disclosure relates to a vehicle tailgate air curtain and an operation method thereof. More particularly, the present disclosure relates to a vehicle tailgate air curtain and an operation method thereof, which is applicable to a tailgate of a vehicle.

### (b) Description of the Related Art

Camping using vehicles is becoming a trend, and vehicles with specialized features for this are gradually increasing. When camping using a vehicle, the rear seats can be folded to create a flat interior space that can be used like a tent. At this time, if the interior space is used with the tailgate open, a sense of openness may be felt, but not only will pests and polluted air may enter, but the efficiency of the interior air conditioning system will also decrease.

### SUMMARY

The present disclosure attempts to provide a tailgate air curtain including an air curtain installed between a tailgate and a cargo compartment of a vehicle, an air guide, and a controller, and a method of operating the tailgate air curtain.

A vehicle tailgate air curtain may include a tailgate attached to a first portion of a cargo compartment frame of a vehicle, an air curtain attached to a second portion of the cargo compartment frame, and an air guide attached adjacent to the first portion of the cargo compartment frame, where, while the tailgate is open an inner side surface of the tailgate has a round shape in a direction away from the air curtain, the air guide is disposed between the tailgate and the first portion, and the air curtain is disposed opposite to the air guide.

The vehicle tailgate air curtain may further include a controller for operating and controlling at least one of the tailgate, the air curtain, and the air guide, where the controller is connected to a control panel attached to an interior of a cargo compartment.

The control panel may provide a user with an interface for turning on and off of the air curtain or changing of a position or a shape of the air guide, and the air curtain emits wind toward the air guide.

The air guide may be configured to block a space between the first portion of the cargo compartment frame and the tailgate, and guide air emitted from the air curtain toward the inner side surface of the tailgate.

The air guide may include an elastic material, and is deformed into a round shape that is convex away from the air curtain in order to guide the wind when the tailgate is opened.

The air guide may include a fixing portion of a hinge shape fixed to the cargo compartment frame to be adjacent to the first portion, a connection portion having a first end coupled to the fixing portion, and configured to move at a designated angle around the fixing portion as a central axis whenever the tailgate is opened and closed, and a guide portion coupled to a second end of the connection portion, disposed inside the cargo compartment according to a movement of the connection portion when the tailgate is closed, and configured to move according to the movement of the connection portion to be disposed between the first portion and the tailgate when the tailgate is opened.

The connection portion may include a rotation axis at the second end, and the guide portion may rotate around the rotation axis as a center, to guide the wind emitted from the air curtain toward the inner side surface of the tailgate.

The tailgate may adjust an open angle by a preset angle when the air curtain is turned on in an open state.

The controller may be connected to a user terminal through a network, and provide the interface through an application of the user terminal.

The air curtain may include a first air curtain and a second air curtain, and the first air curtain and the second air curtain are disposed to face each other.

An operation method of a tailgate air curtain may include opening a tailgate, disposing an air guide between the tailgate and a first portion of a cargo compartment frame to which the tailgate is connected, emitting wind toward the air guide by an air curtain disposed in a second portion of the cargo compartment frame, and guiding the wind toward an inner side surface of the tailgate, by the air guide, where the inner side surface of the tailgate has a round shape in a direction away from the air curtain.

The opening the tailgate may include adjusting an open angle of the tailgate at a preset angle when the air curtain starts emitting wind.

The disposing the air guide between the tailgate and the first portion of the cargo compartment frame to which the tailgate connected may include deforming a shape of the air guide into a round shape that is convex away from the direction away from the air curtain.

The disposing the air guide between the tailgate and the first portion of the cargo compartment frame to which the tailgate connected may include moving a guide portion coupled to a connection portion rotating around a fixing portion fixed to the cargo compartment frame as a central axis from an inner side of the cargo compartment to a space between the tailgate and the first portion, and rotating the guide portion around a rotation axis of the connection portion to block the space.

The disposing the air guide between the tailgate and the first portion of the cargo compartment frame to which the tailgate connected is performed when the air curtain is turned on.

The emitting wind toward the air guide by the air curtain may include collecting external information including temperature, time, and weather, and adjusting at least one of strength, direction, and temperature of wind emission based on the external information.

The operation method of a tailgate air curtain may further include stopping an operation of the air curtain when the tailgate starts to be closed.

When a tailgate is open in a camping mode operation of the vehicle, a vehicle tailgate air curtain and an operation method thereof according to an embodiment may activate the operation of the tailgate air curtain installed on a chassis portion of the tailgate to provide a feeling of openness, block pests and air contamination, and improve the cooling and heating efficiency.

### BRIEF DESCRIPTION OF THE FIGURES

FIG. 1 is a perspective view showing a vehicle tailgate air curtain according to an embodiment.

FIG. 2 and FIG. 3 are side views showing a vehicle tailgate air curtain according to an embodiment.

FIG. 4 is a side view showing a vehicle tailgate air curtain according to another embodiment of the present disclosure.

FIG. 5 and FIG. 6 are perspective views showing a vehicle tailgate air curtain according to another embodiment of the present disclosure.

FIG. 7 is a flowchart showing an operation method of a vehicle tailgate air curtain according to an embodiment.

FIG. 8 shows a vehicle tailgate air curtain linked with a user terminal according to an embodiment.

FIG. 9 is a flowchart showing an operation method of a vehicle tailgate air curtain according to an embodiment.

FIG. 10 shows an interface displayed on a mobile app of a user terminal according to an embodiment.

FIG. 11 shows an example a computing device according to an embodiment.

### DETAILED DESCRIPTION

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Hereinafter, embodiments of the present disclosure will be described with reference to the drawings.

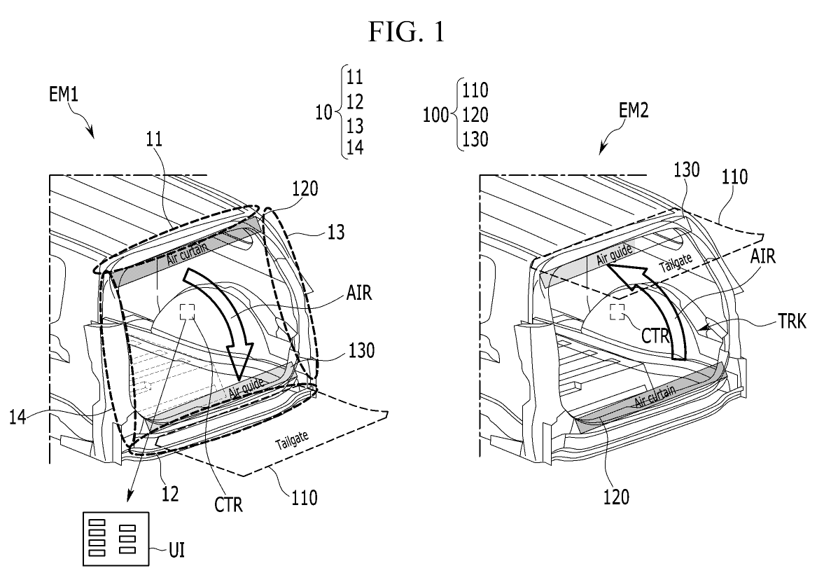

FIG. 1 is a perspective view showing a tailgate air curtain for a vehicle according to an embodiment.

A tailgate air curtain 100 of a vehicle includes an air curtain 120 installed on a tailgate 110, to block the inflow of pests and contaminated air, and to improve cooling and heating efficiency.

For example, the tailgate air curtain 100 of a vehicle includes the air curtain 120 installed together with the tailgate 110 in a cargo compartment TRK of an SUV vehicle type.

The tailgate air curtain 100 of a vehicle activates an operation of the air curtain 120 during a camping mode operation of the vehicle, thereby providing a feeling of openness in an open state of the tailgate 110, while blocking pests and air contamination and improving cooling and heating efficiency.

FIG. 1 shows the first embodiment EM1 and the second embodiment EM2 of the tailgate air curtain 100 of a vehicle.

Referring to FIG. 1, the tailgate air curtain 100 of a vehicle may include the tailgate 110, the air curtain 120, and an air guide 130.

The tailgate 110 may be attached to the cargo compartment TRK of the vehicle. The tailgate 110 may correspond to a door for opening/closing the cargo compartment TRK.

The tailgate 110 may be attached to a portion of a cargo compartment frame 10 of the vehicle. The tailgate 110 may have an open state or a closed state.

When the air curtain 120 is turned ON in the open state, the tailgate 110 may have its open angle adjusted by a preset angle. The open angle of the tailgate 110 may include an optimal angle for circulating a wind AIR emitted from the air curtain 120 to the outside.

The air curtain 120 is installed in an open space of the cargo compartment TRK, and outlets a strong wind. Through an air barrier wall formed by the wind, the air curtain 120 may serve to prevent the cooled/heated air inside the vehicle from escaping to the outside, and to block dust, insects, odors, or the like, entering from the outside.

The air curtain 120 may be attached to a portion of the cargo compartment frame 10. The air curtain 120 may be attached to a portion opposite to a portion in the cargo compartment frame 10 to which the tailgate 110 is attached.

Therefore, the air curtain 120 may emit the wind AIR in a direction toward the tailgate 110.

The air guide 130 may be disposed between the tailgate 110 and the air curtain 120. The air guide 130 may be disposed between the tailgate 110 and the cargo compartment frame 10 to which the tailgate 110 is attached.

The air guide 130 may serve to guide the wind AIR emitted from the air curtain 120 toward an inner side surface of the tailgate 110.

In an embodiment, the air curtain 120 may emit the wind AIR in a direction toward the tailgate 110. Specifically, the air curtain 120 may emit the wind AIR in a direction toward the air guide 130, and the air guide 130 may guide the emitted wind AIR toward the tailgate 110.

In the first embodiment EM1, the air curtain 120 may be disposed in a first portion 11 of the cargo compartment frame 10. The tailgate 110 may be attached to a second portion 12 on an opposite side of the first portion 11. The air guide 130 may be adjacently disposed on the second portion 12 to which the tailgate 110 is attached.

In the second embodiment EM2, the tailgate 110 may be attached to the first portion 11. At this time, the air curtain 120 may be disposed in the second portion 12 that is opposite to the first portion 11. In the same way, the air guide 130 may be disposed on the first portion 11 to which the tailgate 110 is attached.

In common with the first embodiment EM1 and the second embodiment EM2, the air curtain 120 may be disposed opposite to the air guide 130.

The tailgate air curtain 100 of a vehicle may include a controller CTR.

The controller CTR may control the operation of at least one of the tailgate 110, the air curtain 120, and the air guide 130.

The controller CTR may include a control panel UI attached to the inner side surface of the cargo compartment TRK. The control panel UI may include a plurality of manipulation means.

The driver or user may provide an input for the operation of at least one of the tailgate 110, the air curtain 120, and the air guide 130, through a manipulation means (e.g., buttons) of the control panel UI.

The controller CTR may control the operation of at least one of the tailgate 110, the air curtain 120, and the air guide 130 according to the input of the control panel UI.

For example, the control panel UI may include a manipulation means (or, interface) for turning on and off of the air curtain 120 or changing the position and shape of the air guide 130, and according to the input of the user, the controller CTR may perform the control for turning on and off of the air curtain 120 or changing the position and shape of the air guide 130.

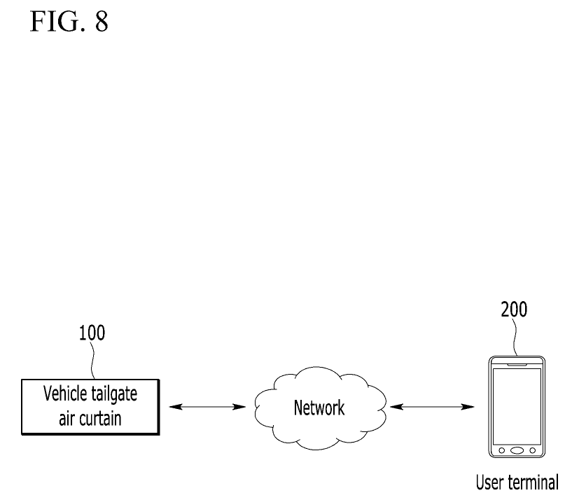

The controller CTR may be connected to a user terminal through a network, and may provide an interface through an application of the user terminal. The description of FIG. 8 may be referred to.

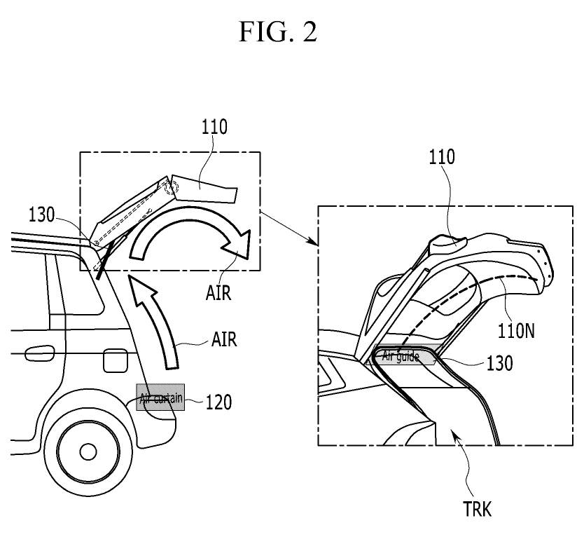

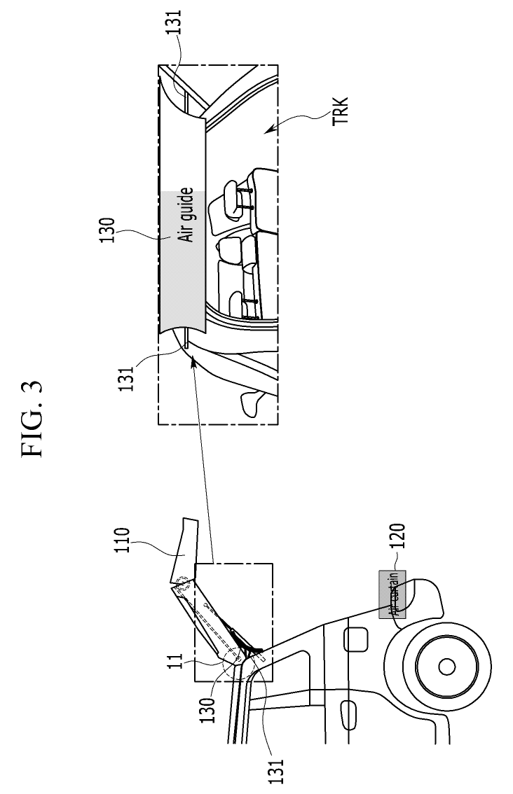

FIG. 2 and FIG. 3 are side views showing the tailgate air curtain for a vehicle according to an embodiment.

FIG. 2 and FIG. 3 are drawings showing the air guide 130 according to an embodiment.

FIG. 2 and FIG. 3 illustrates that the tailgate 110 is opened while the cargo compartment TRK is open, and shows a direction of the wind AIR during the operation of the air curtain 120 while the tailgate 110 is open.

Referring to FIG. 2, an inner side surface 110N of the tailgate 110 may have a concave (or convex) round shape.

The inner side surface 110N of the tailgate 110 may have a concave (or convex) shape in a direction away from the air curtain 120.

The air guide 130 may have a plank shape.

The air guide 130 may be disposed between the air curtain 120 and the tailgate 110, and the air curtain 120 may emit the wind AIR toward the air guide 130.

The air guide 130 may guide the wind AIR toward the inner side surface 110N of the tailgate 110. The wind AIR may circulate along the inner side surface 110N of the tailgate 110.

Referring to FIG. 3, the air guide 130 may have a curvature. While the cargo compartment TRK is closed and the tailgate 110 is not open, the air guide 130 does not have a curvature and has a flat plank shape.

However, when the tailgate 110 is opened, the air guide 130 may have a predetermined curvature. That is, the air guide 130 may have a concave (or convex) round shape in a direction away from the air curtain 120.

That is, the air guide 130 may include an elastic material. The air guide 130 may include a rubber material, and is not limited thereto.

To this end, the tailgate air curtain 100 of a vehicle (see FIG. 1) may include a structure 131 for fixing the air guide 130 to the first portion 11 of the cargo compartment frame.

While the structure 131 fixes the air guide 130, it may move according to opening or closing of the tailgate 110 so that the air guide 130 may have a round or flat shape.

For example, the structure 131 may include two or more rods having predetermined lengths, and the two or more rods may have different positions in the open state or the closed state of the tailgate 110.

The air guide 130 may block an empty space between the first portion 11 and the tailgate 110 attached to the first portion 11, to prevent the wind AIR from escaping to the outside without being guided toward the tailgate 110.

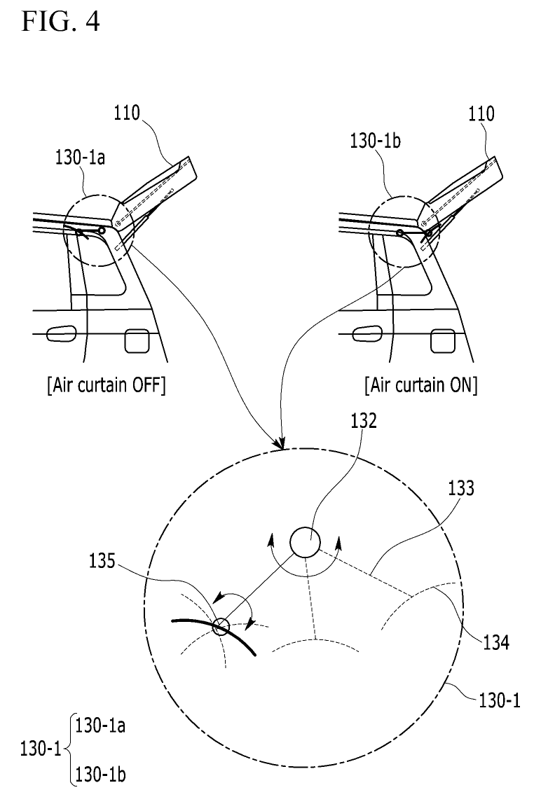

FIG. 4 is a side view showing the tailgate air curtain for a vehicle according to another embodiment of the present disclosure.

FIG. 4 shows an air guide 130-1 according to another embodiment that is different from that of FIG. 2 and FIG. 3.

Referring to FIG. 4, the air guide 130-1 may include a fixing portion 132, a connection portion 133 and a guide portion 134.

The fixing portion 132 may have a hinge shape. The fixing portion 132 may be disposed in an interior of the cargo compartment TRK, and may be adjacent to the first portion 11 (see FIG. 1) of the cargo compartment frame to which the tailgate 110 is attached.

The connection portion 133 may have a first end coupled to the fixing portion 132, and may move at a designated angle around the fixing portion 132 as a central axis whenever the tailgate 110 is opened and closed.

The guide portion 134 may be coupled to a second end of the connection portion 133.

For example, the connection portion 133 may include a rotation axis 135 at its second end. The guide portion 134 may rotate around the rotation axis 135 as a center, to guide the wind or air AIR (see FIG. 1) emitted from the air curtain 120 (see FIG. 1) toward the inner side surface 110N (see FIG. 2) of the tailgate 110.

When the tailgate 110 is closed or when the air curtain is turned off, the guide portion 134 may be disposed inside the cargo compartment according to a movement of the connection portion 133.

When the tailgate 110 is opened or when the air curtain is turned on, the guide portion 134 may move according to the movement of the connection portion 133, to be disposed between the first portion 11 and the tailgate 110.

Alternatively, in response to the user’s input through the control panel UI, the air guide 130-1 may move around the fixing portion 132.

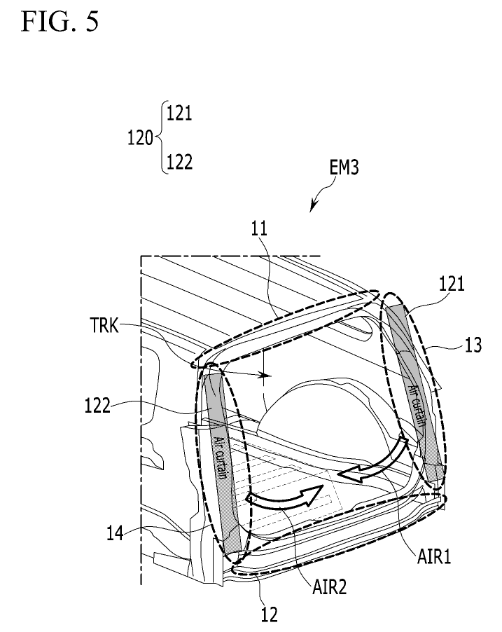

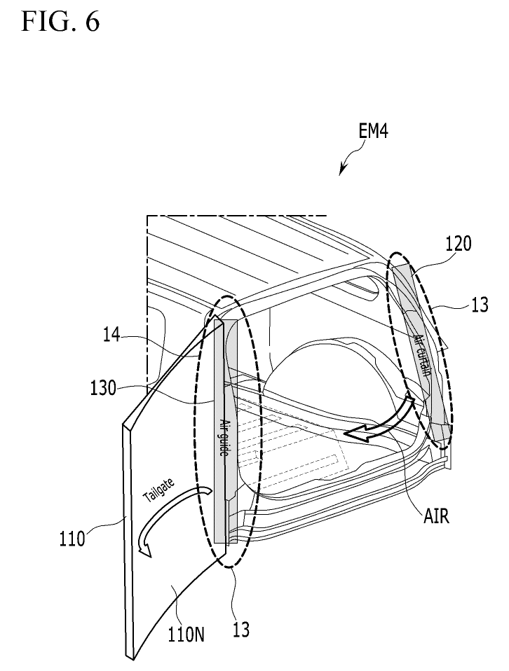

FIG. 5 and FIG. 6 are perspective views showing the tailgate air curtain for a vehicle according to another embodiment of the present disclosure.

FIG. 5 is a drawing showing an arrangement of the air curtain 120 according to the third embodiment EM3.

In FIG. 5, the air curtain 120 may include a first air curtain 121 and a second air curtain 122.

The first air curtain 121 and the second air curtain 122 may be disposed to face each other.

For example, the first air curtain 121 may be disposed in a third portion 13, and the second air curtain 122 may be disposed in a fourth portion 14.

The first air curtain 121 may emit the wind AIR1 in a direction toward the second air curtain 122, and the second air curtain 122 may emit the wind AIR2 in a direction toward the first air curtain 121.

The winds AIR1 and AIR2 may collide with each other to form a wind barrier wall, and the air wall may block contamination of the interior air of the cargo compartment TRK and improve cooling and heating efficiency.

FIG. 6 is a drawing showing an arrangement of the tailgate 110, the air curtain 120, and the air guide 130 according to the fourth embodiment EM4.

In FIG. 6, the air curtain 120 and the air guide 130 may be disposed on a side surface portion of the cargo compartment frame of the vehicle, respectively.

The air curtain 120 may be disposed in the third portion 13, and the air guide 130 may be disposed on the fourth portion 14 in the opposite side. In this case, the tailgate 110 may be attached to the fourth portion 14 where the air guide 130 is disposed.

Like other embodiments, the air guide 130 may guide the wind AIR of the air curtain 120 toward the inner side surface 110N while the tailgate 110 is open.

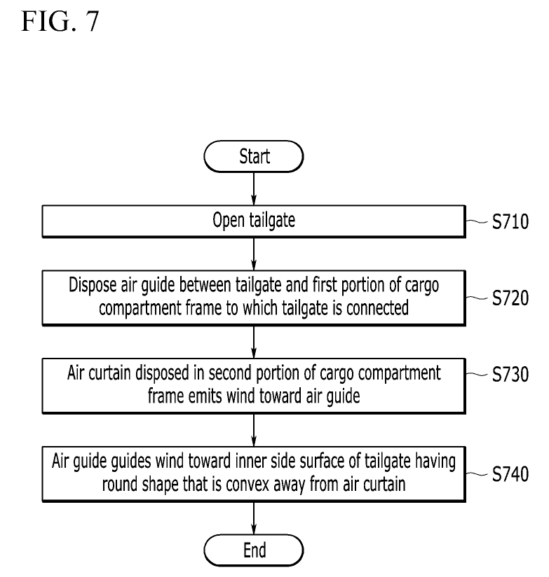

FIG. 7 is a flowchart showing the tailgate air curtain for a vehicle according to an embodiment operation method. The operation method of a tailgate air curtain for a vehicle of FIG. 7 may be performed through the tailgate air curtain for a vehicle of FIG. 1 to FIG. 7.

In FIG. 7, at step S710, the tailgate air curtain 100 of a vehicle (see FIG. 1) may open the tailgate.

When the air curtain starts emitting wind, the tailgate air curtain 100 of a vehicle may adjust the open angle of the tailgate at a preset angle.

At step S720, the tailgate air curtain 100 of a vehicle may dispose the air guide between the tailgate and the first portion of the cargo compartment frame to which the tailgate connected.

When the air curtain is turned on, the tailgate air curtain 100 of a vehicle may dispose the air guide between the tailgate and the first portion to which the tailgate is attached.

When the tailgate is opened, the tailgate air curtain 100 of a vehicle may deform the shape of the air guide to a concave (or convex) round shape in a direction away from the air curtain.

In an embodiment, the tailgate air curtain 100 of a vehicle may move the guide portion coupled to the connection portion rotating around the fixing portion fixed to the cargo compartment frame as a central axis from the inner side of the cargo compartment to a space between the tailgate and the first portion.

The tailgate air curtain 100 of a vehicle may rotate the guide portion around the rotation axis of the connection portion to block the space.

At step S730, the tailgate air curtain 100 of a vehicle may emit wind toward the air guide through the air curtain disposed in the second portion of the cargo compartment frame.

The tailgate air curtain 100 of a vehicle may collect external information including temperature, time, and weather, and may adjust at least one of wind emission strength, direction, and temperature based on the collected external information.

At step S740, the tailgate air curtain 100 of a vehicle may guide the wind toward the inner side surface of the tailgate having concave (or convex) round shape in a direction away from the air curtain through the air guide.

When the tailgate starts to be closed, the tailgate air curtain 100 of a vehicle may stop the operation of the air curtain.

FIG. 8 is a drawing showing the tailgate air curtain for a vehicle linked with the user terminal according to an embodiment.

The tailgate air curtain 100 of a vehicle may be connected to a user terminal 200 through a network. For example, the controller CTR (see FIG. 1) may be connected to the user terminal 200 through a network.

Therefore, the user may control the tailgate air curtain 100 of a vehicle including the controller CTR through the user terminal 200.

That is, the user may perform manipulation of the tailgate air curtain 100 of a vehicle by using not only the control panel UI (see FIG. 1) inside the cargo compartment but also an interface provided from an application of the user terminal 200.

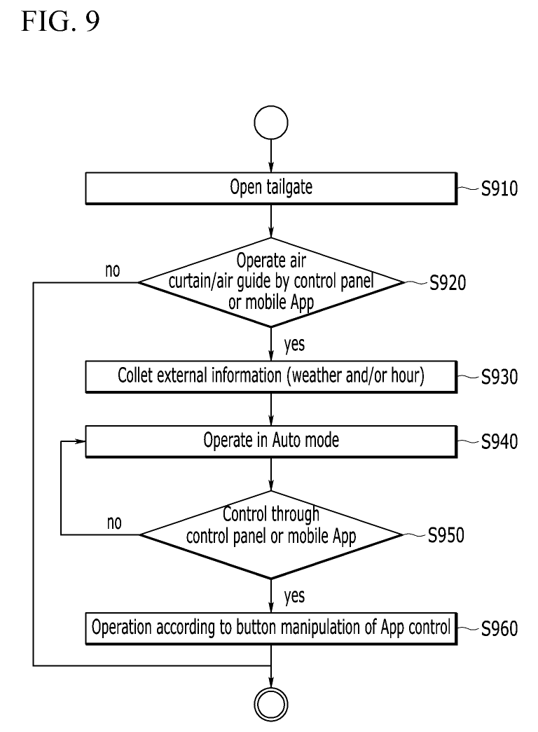

FIG. 9 is a flowchart showing the tailgate air curtain for a vehicle according to an embodiment operation method.

In FIG. 9, at step S920, when the tailgate is opened at step S910, the air curtain and/or the air guide may be executed through a mobile app control of the control panel or the user terminal.

At step S930, the tailgate air curtain 100 of a vehicle (see FIG. 1) may collect external information including weather and time.

At step S940, the tailgate air curtain 100 of a vehicle may operate in an Auto mode based on the collected external information. That is, the tailgate air curtain 100 of a vehicle may control a wind strength of the air curtain, a direction and position of the air guide based on the external information.

When the user input is received through the control panel or the mobile app at step S950, the tailgate air curtain 100 of a vehicle may operate the air curtain and/or the air guide in response thereto, at step S960.

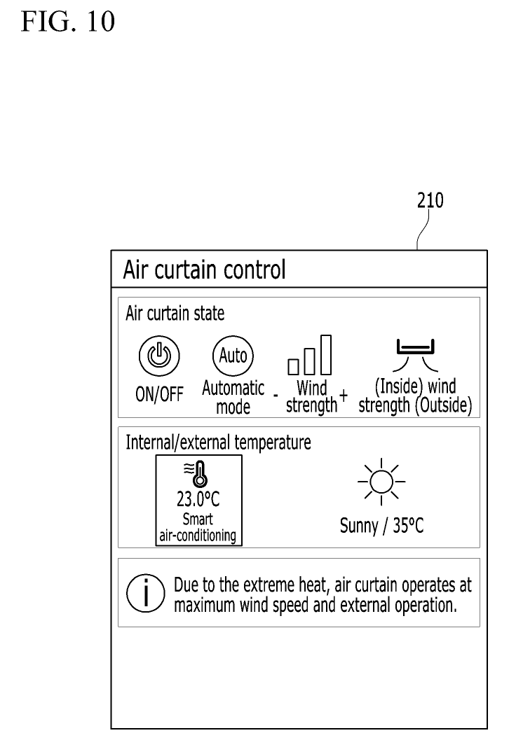

FIG. 10 shows an example interface displayed on the mobile app of the user terminal according to an embodiment.

The tailgate air curtain 100 of a vehicle (see FIG. 1) may control the tailgate, the air curtain and/or the air guide by linking with a mobile app 210 provided by the user terminal 200 (see FIG. 8).

In FIG. 10, the mobile app 210 displayed on the user terminal 200 may provide an interface for remotely turning on and off the air curtain in the open state of the tailgate.

The mobile app 210 may provide an interface for controlling or confirming the current wind strength and wind direction of the air curtain.

The mobile app 210 may provide an interface for controlling or displaying the internal temperature and the external temperature.

The mobile app 210 may provide description of the wind strength and wind direction when operate in the Auto mode.

The mobile app 210 may optionally provide a setting for automatically operating the air curtain when the tailgate is open for a preset time or more.

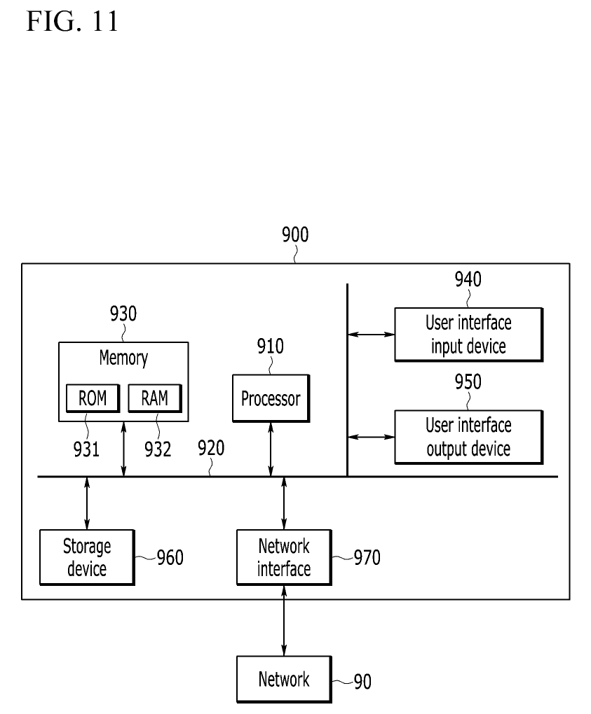

FIG. 11 shows an example a computing device according to an embodiment.

Referring to FIG. 11, a tailgate air curtain for a vehicle and an operation method thereof according to embodiments may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 10.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some components or functions of a vehicle tailgate air curtain and an operation method thereof according to the embodiments may be implemented as programs or software executed by the computing device 900, and the programs or software may be stored in a computer-readable medium.

In some embodiments, at least some configurations or functions of a vehicle tailgate air curtain and an operation method thereof according to an embodiment may be implemented by using hardware or circuitry of the computing device 900, or may also be implemented as separate hardware or circuitry that may be electrically connected to the computing device 900.

For example, the controller CTR (see FIG. 1) of the tailgate air curtain for a vehicle may be implemented as the computing device 900. That is, the controller CTR may be implemented as a program or software executed by the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

1. A vehicle tailgate air curtain, comprising:
a tailgate attached to a first portion of a cargo compartment frame of a vehicle;
an air curtain attached to a second portion of the cargo compartment frame; and
an air guide attached adjacent to the first portion of the cargo compartment frame;
wherein, when the tailgate is open:
an inner side surface of the tailgate has a round shape in a direction away from the air curtain;
the air guide is positioned between the tailgate and the first portion; and
the air curtain is positioned opposite to the air guide.

2. The vehicle tailgate air curtain of claim 1, further comprising a controller configured to operate and control at least one of the tailgate, the air curtain, and the air guide,
wherein the controller is connected to a control panel attached to an interior of a cargo compartment.

3. The vehicle tailgate air curtain of claim 2, wherein the control panel is configured to provide a user with an interface for turning the air curtain on and off, or for changing a position or a shape of the air guide, and wherein the air curtain is configured to emit wind toward the air guide.

4. The vehicle tailgate air curtain of claim 3, wherein the air guide is configured to block a space between the first portion of the cargo compartment frame and the tailgate, and guide air emitted from the air curtain toward the inner side surface of the tailgate.

5. The vehicle tailgate air curtain of claim 4, wherein the air guide comprises an elastic material, and is configured to deform into a convex shape facing away from the air curtain o guide the wind when the tailgate is opened.

6. The vehicle tailgate air curtain of claim 4, wherein the air guide comprises:
a fixing portion comprising a hinge shape fixed to the cargo compartment frame adjacent to the first portion;
a connection portion having a first end coupled to the fixing portion, and configured to move at a designated angle around the fixing portion as a central axis when the tailgate is opened and closed; and
a guide portion coupled to a second end of the connection portion, positioned inside the cargo compartment according to a movement of the connection portion when the tailgate is closed, and configured to move according to the movement of the connection portion to be positioned between the first portion and the tailgate when the tailgate is opened.

7. The vehicle tailgate air curtain of claim 6, wherein:
the connection portion comprises a rotation axis at the second end; and
the guide portion is configured to rotate around the rotation axis as a center, to guide the wind emitted from the air curtain toward the inner side surface of the tailgate.

8. The vehicle tailgate air curtain of claim 1, wherein the tailgate is configured to adjust an open angle by a preset angle when the air curtain is turned on in an open state.

9. The vehicle tailgate air curtain of claim 3, wherein the controller is connected to a user terminal through a network, and configured to provide the interface through an application of the user terminal.

10. The vehicle tailgate air curtain of claim 1, wherein the air curtain comprises a first air curtain and a second air curtain, and the first air curtain and the second air curtain face each other.

11. An method of operating a tailgate air curtain, comprising:
opening a tailgate;
positioning an air guide between the tailgate and a first portion of a cargo compartment frame connected to the tailgate;
emitting wind toward the air guide by an air curtain positioned in a second portion of the cargo compartment frame; and
guiding the wind toward an inner side surface of the tailgate, by the air guide;
wherein the inner side surface of the tailgate has a round shape in a direction away from the air curtain.

12. The method of claim 11, wherein opening the tailgate comprises adjusting an open angle of the tailgate at a preset angle when the air curtain starts emitting wind.

13. The method of claim 11, wherein positioning the air guide between the tailgate and the first portion of the cargo compartment frame comprises deforming a shape of the air guide into a convex shape opposite to the direction away from the air curtain.

14. The method of claim 11, wherein positioning the air guide between the tailgate and the first portion of the cargo compartment frame comprises:
moving a guide portion coupled to a connection portion rotating around a fixing portion fixed to the cargo compartment frame as a central axis from an inner side of the cargo compartment to a space between the tailgate and the first portion; and
rotating the guide portion around a rotation axis of the connection portion to block the space.

15. The method of claim 14, wherein positioning the air guide between the tailgate and the first portion of the cargo compartment frame is performed when the air curtain is turned on.

16. The method of claim 11, wherein emitting wind toward the air guide comprises:
collecting external information comprising temperature, time, and weather; and
adjusting at least one of strength, direction, and temperature of wind emission based on the external information.

17. The method of claim 11, further comprising stopping an operation of the air curtain when the tailgate begins closing.

18. The method of claim 11, further comprising:
turning the air curtain on and off, by a control panel attached to an interior of a cargo compartment; and
changing a position or a shape of the air guide by the control panel.

19. The method of claim 18, wherein the control panel includes a user interface.

20. The method of claim 19, wherein the controller is connected to a user terminal through a network, and configured to provide the user interface through an application of the user terminal.
